(19) United States
(12) Patent Application Publication
(10) Pub. No.: US 2023/0263678 A1
(43) Pub. Date: Aug. 24, 2023

(54) LEG AND FOOT ELEVATOR

(71) Applicant: David Elliot SHAFFER, Great Neck, NY (US)

(72) Inventor: David Elliot SHAFFER, Great Neck, NY (US)

(21) Appl. No.: 18/110,425

(22) Filed: Feb. 16, 2023

Related U.S. Application Data
(60) Provisional application No. 63/311,729, filed on Feb. 18, 2022.

(51) Int. Cl. A61G 7/075; A61G 13/12

(52) U.S. Cl. CPC A61G 7/0755; A61G 13/1245

(57) ABSTRACT

A device for elevating the legs and feet of a supine patient is formed by a unitary body having a top surface and a bottom surface, a front edge, a rear edge and two opposing side edges. Two open channels extending from the front edge to the rear edge are formed in the top surface and are configured to accommodate the lower legs or feet of the patient. The channels are separated by a divider. The channels are sloped upward from rear to front, so that the feet are elevated the most. In use, the patient places both of their lower legs into the channels, with the feet extending beyond the front edge of the device. The elevation of the device prevents the feet from touching the supporting surface.

### CROSS-REFERENCE TO RELATED APPLICATIONS

This application claims priority under 35 USC 119(e) of U.S. Provisional Pat. Application Serial No. 63/311,729, filed on Feb. 18, 2022, the disclosure of which is herein incorporated by reference.

### BACKGROUND OF THE INVENTION

### 1. Field of the Invention

This invention relates to a device for elevating the legs and feet of a patient while they are in a supine position. In particular, the invention related to a device for elevating the legs and feet of a patient, which is portable and allows movement of the legs and feet while in use.

### 2. The Prior Art

There are many people who are confined to their beds and require additional support to elevate their legs and feet, in particular to reduce swelling. Many of these devices keep the patient stationary and prevent any movement of the legs and feet, which is detrimental to maintenance of muscle tone and flexibility.

### SUMMARY OF THE INVENTION

It is therefore an object of the invention to provide a device for elevating the legs and feet of a patient that is portable, easy to manufacture and use, and which allows for adequate movement of the patient’s legs and feet during use.

These objects are accomplished by a device for elevating the legs and feet of a patient, comprising a unitary body having a top surface and a bottom surface, a front edge, a rear edge and two opposing side edges, wherein two open channels extending from the front edge to the rear edge are formed in the top surface The channels are sized and configured to accommodate the lower legs of the patient, with the feet extending over the edge. The channels are separated by a divider. The channels are indented into the unitary body, so that the top surface of the unitary body comprises the top of the side edges and the top of the divider between the channels. In use, the patient places both of their lower legs into the channels, with the feet extending beyond the front edge of the device. The elevation of the device prevents the feet from touching the supporting surface.

In one embodiment, the channels extend parallel to each other. The channels can have a constant width along their length from the front edge to the rear edge, or can vary in width. The device varies in thickness from the front edge to the rear edge, so that the height of the channels varies from the front edge to the rear edge. The channels have the lowest elevation at the rear edge and the highest elevation at the front edge, where the feet are to be positioned, so as give the feet the maximal amount of elevation. Alternatively, the device could be turned around, if the user desired the feet to have a lower elevation than the legs. Preferably, the channels each have a substanially semicircular cross-section. The cross-section of each channel preferably extends over a radial extent of less than or equal to 180°, to allow for more movement and comfort of the patient. The channels not only help keep the legs in a more straightened alignment, it also helps in preventing leg contractures keeping the legs straight, and prevents the knees from rubbing, which may result in irritation and possible ulcerations.

The device of the present invention removes the load on the foot/ankle and leg and is used in both the prevention and treatment of pressure sores (decubitus ulcers), controlling edema in the lower extremity, controlling foot and leg contractures, and aiding in preventing the knees from rubbing together. The device is constructed in such a manner to be durable enough to allow the leg, foot, and ankle to be suspended so that bony prominences will not cause additional areas of pressure over areas prone to sensitive skin and tissue breakdown. The device is constructed so as to be dynamic in nature, allowing a bedbound patient to have the freedom of movement (unlike traditional off-loading devices that keep a bed bound patient stationary). This dynamic feature allows the patient the freedom of movement which can be beneficial to muscles, tendons, and circulatory system. The channels of the device help keep the legs in a more straightened alignment, as well assist in preventing leg contractures keeping the legs straight.

In one embodiment, the freedom of movement is enhanced by constructing the bottom surface curved from one side edge to the opposite side edge. This allows the device to move with the patient, if their weight shifts from one side to the other, or if they attempt to lie on one side. This movement increases the comfort level of the patient, as no pressure points build up on the portions of the body accommodated in the channels.

The device can be constructed of any size, but is preferably constructed so that the lower extremities are elevated at least 15-20° from horizontal. In one embodiment, the distance between the front edge and rear edge is approximately 12 inches, and the distance between, the two side edges is 14 inches, and an elevation of the channels at the front edge is 3.5 inches. Preferably, the device is formed so that the channels increase in height from the rear edge (posterior) to the front edge (anterior) edge, and in most cases, the bottom of each channel varies between 1-3 inches in height from the bottom surface of the device and preferably 2-4 inches, from the rear edge to the front edge. The overall thickness of the device can vary so as to accommodate channels of constant dimensions yet varying height from the bottom of the device. Thus, the dimensions of each channel can remain constant while the thickness of the device increases from rear to front, giving the channels their desired tilt. Alternatively, the depth of the channels can vary with the thickness of the device being constant.

The device is preferably constructed of a lightweight material, such as foam. Other materials such as molded plastic could also be used, but a flexible material is preferred, so as to be able to accommodate legs of all sizes, and to allow for maximum mobility during use.

The channels are spaced from each other by enough of a distance to prevent the knees of the patient from touching. This distance, between the inside walls at the top of each channel is at least 1 inch, but preferably at least 2 or more inches.

A support layer in the form of a strip may be connected to the bottom surface of the device at the front end to increase a height of the front end above the resting support surface. The support layer is preferably removable and interchangeable with additional support layers of differing heights, so that the device is adjustable between different patients or to accommodate different needs. The support layer can be connected to the device by any suitable means, such as hook-and-loop type closure, or removable adhesive. The support layer can be made of any suitable material, such as foam or plastic.

In another embodiment, a removable cover layer can be used with the device, to prevent dirt or other contaminants from reaching the device itself. The cover layer can be made of woven or nonwoven fabric, paper, plastic or any other suitable material, and can be washable or disposable.

The device of the present invention is dynamic, enabling a patient in the supine position to move one or both legs to improve circulation, musculature and increasing the ability to move and exercise while in a supine position

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a top and rear view of the device according to the invention;

FIG. 2 shows a cross-sectional view along lines II-II of FIG. 1;

FIG. 3 shows a side view of the device in use, with the top section cut away to show the depth of the channels;

FIG. 4 shows a side view of the device in use with the support strip attached, and with the top section cut away to show the depth of the channels; and

FIG. 5 shows a top and front end view of the device with a protective covering attached.

### DETAILED DESCRIPTION OF THE PREFERRED EMBODIMENTS

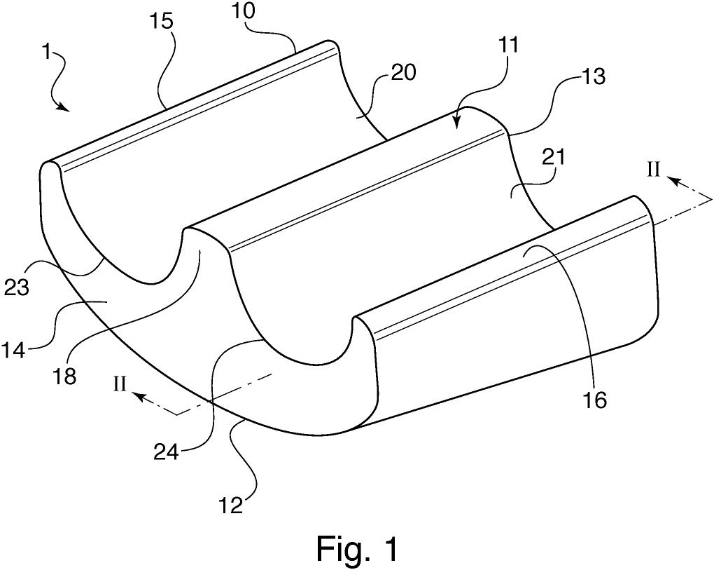

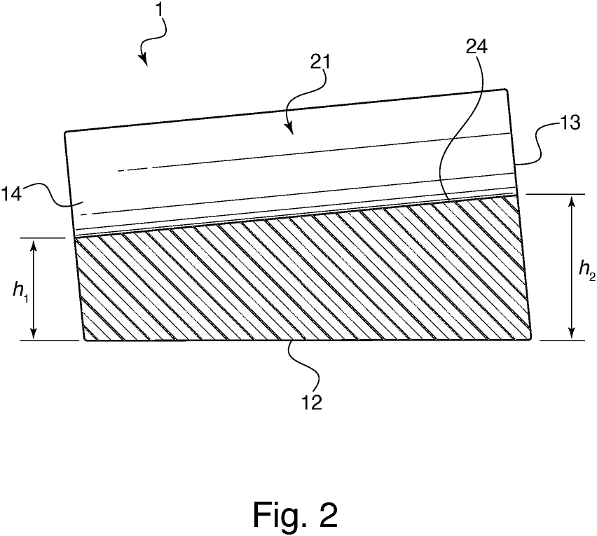

Referring now in detail to the drawings and, in particular, FIGS. 1 and 2 show a first embodiment of the device 1, which comprises a unitary body 10, having a top surface 11, a bottom surface 12, a front edge 13, a rear edge 14, a first side edge 15 and a second side edge 16. Channels 20, 21 for accommodating the lower legs of the patient are formed into the top surface 11, and extend from the front edge 13 to the rear edge 14 and have a bottom surface 23, 24. Channels 20, 21 are divided by a divider 18, which is of sufficient width to separate the lower extremities of the patient and prevent the knees from rubbing together. Channels 20, 21 are somewhat semicircular in cross-section and have a constant width and height along the extent of each channel from the front edge 13 to the rear edge 14. Bottom surface 12 is constructed to be concave in shape between side edges 15, 16, so that the device 1 may rock side-to side if pressure is placed on one side vs. the other, allowing for increased mobility and comfort of a patient whose legs are resting in channels 20, 21.

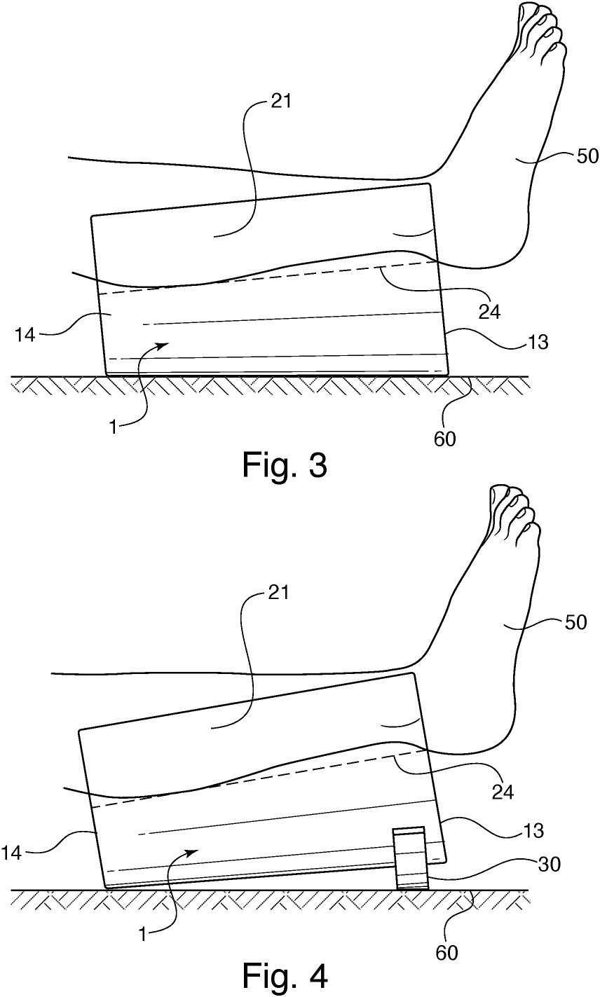

Device 1 is constructed so that the device is thicker at the front edge 13 than at the rear edge 14, with an upwardly sloping top surface 11. Channels 20, 21 are thus disposed as an oblique angle to horizontal when device 1 is resting on a horizontal support surface 60, shown in FIGS. 3 and 4. Thus, channels 20, 21 have a height h₁ from the bottom surface 12 of the device that is smaller at the rear edge 14, than a height h₂ of the channels at the front edge 13 of the device 1. This allows the feet to be located at the highest point of elevation when the device is in use. In particular, it is desirable if the patient’s leg is elevated at an angle a of 15 degrees or more from horizontal.

FIG. 3 shows the device 1 in use by a patient, with the top half cut-away to illustrate the position of the channels and the patient’s legs. The sloped orientation of channels 20, 21 can be seen in broken lines in the side view, so that when the patient’s lower legs are placed into channels 20, 21 of the device, the feet 50 extend out from the device at its greatest height from the supporting surface 60 at front end 13.

FIG. 4 shows a similar view to FIG. 3, but where a support strip 30 is placed underneath front end 13, to raise the front end 13 up from the support surface 60 to add even more height and elevation angle to the device 1. Support strip 30 can be of any desired height, and can be interchangeable with other support strips of different thicknesses to allow the device to be used at a variety of heights and angles, based on the patient’s need. The support strip 30 can be made of foam, fabric layers, plastic or any other suitable material, and can be attached via hook-and-loop type closures, snaps, straps or any other suitable attachment system.

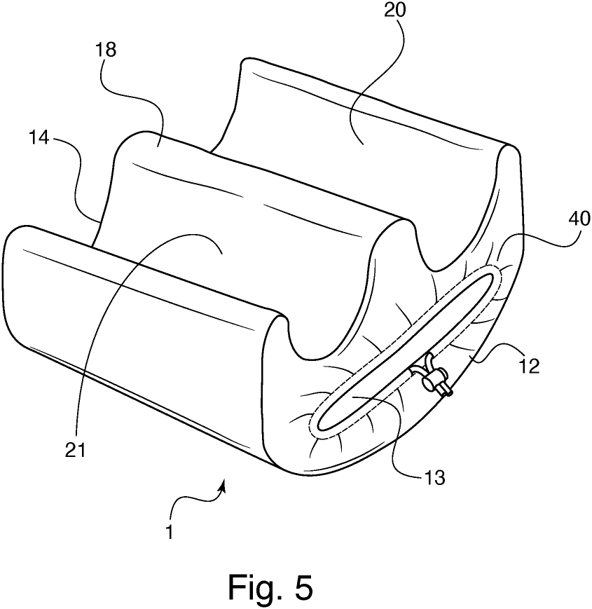

As shown in FIG. 5, a covering 40 can be placed over device 1 to protect device 1 from contaminants. The covering 40 can be disposable or washable, and can be made of any suitable material, such as woven or nonwoven fabric, plastic film or paper. It can be seen from a comparison of FIGS. 1 and 5 that the device is substantially thicker at front end 13, shown in FIG. 5, than at rear end 14, which is shown in FIG. 1.

Accordingly, while only a few embodiments of the present invention have been shown and described, it is obvious that many changes and modifications may be made thereunto without departing from the spirit and scope of the invention.

What is claimed is:

1. A device for elevating the legs and feet of a supine patient, comprising a unitary body having a top surface and a bottom surface, a front edge, a rear edge and two opposing side edges, wherein two open channels extending from the front edge to the rear edge are formed in the top surface, the channels being configured to accommodate and support the legs of the patient.

2. The device according to claim 1, wherein the channels extend parallel to each other.

3. The device according to claim 1, wherein the channels each have a constant width along a length extending from the front edge to the rear edge.

4. The device according to claim 1, wherein the channels are disposed at an increasing distance from the bottom surface, measured from the rear edge to the front edge.

5. The device according to claim 4, wherein the channels have a constant height and width, and wherein a thickness of the device increases from the rear edge to the front edge.

6. The device according to claim 1, wherein the channels each have a substantially semicircular cross-section.

7. The device according to claim 5, wherein the cross-section of each channel extends over a radial extent of not more than 180°.

8. The device according to claim 1, wherein the bottom surface is convex in shape, measured from one side edge to the opposite side edge.

9. The device according to claim 1, wherein the device is constructed of a foam material.

10. The device according to claim 1, wherein the channels are spaced from each other by a distance of at least 2 inches.

11. The device according to claim 1, wherein the channels are indented into the unitary body.

12. The device according to claim 1, further comprising a support strip connected to the bottom surface at the front edge, the support strip increasing a height of the channels at the front edge of the device.

13. The device according to claim 12, wherein the support strip is removable and interchangeable with additional support layers of differing heights.

14. The device according to claim 1, further comprising a removable cover layer surrounding the device.

15. The device according to claim 14, wherein the cover layer is made of a woven fabric, a nonwoven fabric, paper, or plastic film.

16. The device according to claim 5, wherein a lowest point of each channel is spaced from the bottom surface by a distance of at least 2 inches at the rear end and by at least 3 inches at the front end.
